(19) United States
(12) Patent Application Publication
(10) Pub. No.: US 2024/0294429 A1
(43) Pub. Date: Sep. 5, 2024

(54) Thermally Insulative Concrete Made From Biorefinery Byproducts

(71) Applicant: Alliance for Sustainable Energy, LLC, Golden, CO (US)

(72) Inventors: Adewale ODUKOMAIYA, Denver, CO (US); Anastasia Nicole ADAY, Boulder, CO (US); Nicole Renee MENDOZA, Longmont, CO (US); Kerry Christine RIPPY, Golden, CO (US); Michael E. HIMMEL, Littleton, CO (US); Xiaowen CHEN, Arvada, CO (US); Lin Jay SIMPSON, Lakewood, CO (US); Michael Brennan PECHA, Littleton, CO (US); Michael Brandon GRIFFIN, Denver, CO (US)

(21) Appl. No.: 18/585,226

(22) Filed: Feb. 23, 2024

Related U.S. Application Data
(60) Provisional application No. 63/488,210, filed on Mar. 3, 2023.
(60) Provisional application No. 63/516,216, filed on Jul. 28, 2023.

(51) Int. Cl. C04B 26/24; C04B 28/04; C04B 28/26; C04B 103/60; D21C 11/00

(52) U.S. Cl. CPC C04B 26/24; C04B 28/04; C04B 28/26; D21C 11/0007; C04B 2103/603

(57) ABSTRACT

The utilization of the byproducts from the deacetylation of lignocellulosic biomass from the production of ethanol to create cement additives and/or alternatives to ordinary portland cement (OPC) is described. These byproducts may be used to create black liquor bioash (BLA), activated lignin carbon (ALC), and/or lignin aerogel admixtures. In some embodiments, the byproduct may be combined with at least one binder to form alkali-activated materials (AAMs).

### CROSS-REFERENCE TO RELATED APPLICATIONS

This application claims priority to U.S. Provisional Patent Application No. 63/488,210 filed on Mar. 3, 2023, and U.S. Provisional Patent Application No. 63/516,216 filed on Jul. 28, 2023, the contents of which are incorporated herein by reference in their entirety.

### CONTRACTUAL ORIGIN

This invention was made with United States government support under Contract No. DE-AC36-08GO28308 awarded by the U.S. Department of Energy. The United States government has certain rights in this invention.

### BACKGROUND

Globally, cement companies produce more than four billion tons of cement. Cement, generally known as ordinary portland cement (OPC), in the main ingredient of concrete and its production accounts for approximately 8% of global anthropogenic greenhouse gas emissions, approximately 90% of which come from the cement manufacturing process The primary source of carbon emissions in the cement manufacturing process is during the conversion of limestone (calcium carbonate) to calcium oxide in OPC. This requires temperatures of approximately 1500° C. and releases carbon dioxide (CO₂) as a byproduct of the reaction. Therefore, there remains a need to reduce carbon dioxide emissions due to concrete production.

### SUMMARY

An aspect of the present disclosure is a method including treating a lignin deacetylation byproduct to form a lignin product, and using the lignin product to form a concrete. In some embodiments, the lignin deacetylation byproduct includes a first black liquor, and the treating includes heating the first black liquor. In some embodiments, the heating includes heating the first black liquor to a temperature of less than approximately 600° C., and the lignin product includes a black liquor bioash (BLBA). In some embodiments, the heating is performed in a furnace, and the furnace is configured to heat the first black liquor to a temperature of approximately 575° C. In some embodiments, the using includes combining the BLBA with an aggregate, a silicate, and a binder to form a dry mixture, adding a water and the first black liquor to the dry mixture to form a wet concrete, casting the wet concrete, and curing the wet concrete to form a dry concrete. In some embodiments, the aggregate includes at least one of sand, gravel, or crushed rock. In some embodiments, the binder includes at least one of fly ash, slag, mine tailings, or clay. In some embodiments, the silicate includes at least one of sodium silicate or calcium silicate. In some embodiments, the silicate includes at least one of glass, ceramic, waterglass, granite, gravel, or garnet. In some embodiments, the lignin deacetylation byproduct includes a first black liquor, the treating includes pyrolyzing the first black liquor in a substantially inert environment at a temperature of less than approximately 600° C., and the lignin product includes an activated lignin carbon (ALC). In some embodiments, the using includes combing the ALC with an aggregate, an activator, and a water. In some embodiments, the aggregate includes at least one of sand, gravel, or crushed rock. In some embodiments, the activator includes a cement. In some embodiments, the cement includes at least one of ordinary portland cement or portland limestone cement. In some embodiments, the activator includes a black liquor bioash (BLBA) and a silicate. In some embodiments, the silicate includes at least one of sodium silicate or calcium silicate. In some embodiments, the silicate includes at least one of glass, ceramic, waterglass, granite, gravel, or garnet. In some embodiments, the lignin deacetylation byproduct includes an enzyme hydrolysis (EH) solid, the treating includes heating the EH solid to a temperature of less than approximately 600° C., in which the heating results in an ash. In some embodiments, the using includes combining the lignin product with a cement. In some embodiments, the cement includes at least one of ordinary portland cement or portland limestone cement.

### BRIEF DESCRIPTION OF THE DRAWINGS

Some embodiments of the present disclosure are illustrated in the referenced figures of the drawings. It is intended that the embodiments and figures disclosed herein are to be considered illustrative rather than limiting.

FIG. 1 illustrates a block diagram of a deacetylation and disk refining (DDR) process showing the origin of the lignin deacetylation byproducts utilized in the methods described herein.

FIG. 2 illustrates a method for treating a first black liquor (i.e., a lignin deacetylation byproduct) from the DDR process to form black liquor bioash (BLBA) and using the BLBA to create concrete, according to some aspects of the present disclosure.

FIG. 3 illustrates four samples of concrete created using BLBA, according to some aspects of the present disclosure.

FIG. 4 illustrates a method for treating the first black liquor from the DDR process to form activated lignin carbon (ALC) and using the ALC to create concrete, according to some aspects of the present disclosure.

FIG. 5 illustrates a method for treating enzyme hydrolysis (EH) solids (i.e., a lignin deacetylation byproduct) from the DDR process to form an ash and using the ash to create concrete, according to some aspects of the present disclosure.

REFERENCE NUMERALS

| | |
|---|---|
| 100 | deacetylation and disk refining (DDR) process |
| 105 | milling |
| 110 | deacetylation |
| 115 | separate solids |
| 120 | enzyme hydrolysis |
| 125 | fermentation |
| 135 | distillation |
| 140 | sustainable aviation fuel (SAF) |
| 200 | method |
| 205 | first black liquor |
| 210 | heating |
| 215 | pyrolyzing |
| 220 | activated lignin carbon (ALC) |
| 225 | black liquor bioash (BLBA) |
| 230 | second black liquor |
| 235 | enzyme hydrolysis (EH) solid |
| 240 | ash |
| 250 | treating |
| 255 | using |
| 260 | combining |
| 265 | adding |
| 270 | casting |
| 275 | curing |
| 280 | dry concrete |

### DETAILED DESCRIPTION

The embodiments described herein should not necessarily be construed as limited to addressing any of the particular problems or deficiencies discussed herein. References in the specification to “one embodiment”, “an embodiment”, “an example embodiment”, “some embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

As used herein the term “substantially” is used to indicate that exact values are not necessarily attainable. By way of example, one of ordinary skill in the art will understand that in some chemical reactions 100% conversion of a reactant is possible, yet unlikely. Most of a reactant may be converted to a product and conversion of the reactant may asymptotically approach 100% conversion. So, although from a practical perspective 100% of the reactant is converted, from a technical perspective, a small and sometimes difficult to define amount remains. For this example of a chemical reactant, that amount may be relatively easily defined by the detection limits of the instrument used to test for it. However, in many cases, this amount may not be easily defined, hence the use of the term “substantially”. In some embodiments of the present invention, the term “substantially” is defined as approaching a specific numeric value or target to within 20%, 15%, 10%, 5%, or within 1% of the value or target. In further embodiments of the present invention, the term “substantially” is defined as approaching a specific numeric value or target to within 1%, 0.9%, 0.8%, 0.7%, 0.6%, 0.5%, 0.4%, 0.3%, 0.2%, or 0.1% of the value or target.

As used herein, the term “about” is used to indicate that exact values are not necessarily attainable. Therefore, the term “about” is used to indicate this uncertainty limit. In some embodiments of the present invention, the term “about” is used to indicate an uncertainty limit of less than or equal to ±20%, ±15%, ±10%, ±5%, or +1% of a specific numeric value or target. In some embodiments of the present invention, the term “about” is used to indicate an uncertainty limit of less than or equal to ±1%, ±0.9%, ±0.8%, ±0.7%, ±0.6%, ±0.5%, ±0.4%, ±0.3%, ±0.2%, or ±0.1% of a specific numeric value or target.

Among other things, the present disclosure relates to the utilization of the black liquor byproducts from the deacetylation of lignocellulosic biomass from the production of ethanol to create cement additives and/or alternatives to ordinary portland cement (OPC). These black liquor byproducts may be used to create black liquor bioash (BLA), activated lignin carbon (ALC), and/or lignin aerogel admixtures. In some embodiments, the black liquor byproduct may be combined with at least one binder to form alkali-activated materials (AAMs). These may be bio-based alternative supplementary cementitious materials (SCMs) and may be used in place of OPC or as a supplement to OPC.

For decades, the biomass to biofuels process was not successful in sustaining a new lignocellulose derived biofuels industry and this dilemma was largely due to the high capital cost of the original dilute acid pretreatment process invented in the early 1990's. A more recent, alkaline, ambient pressure, low temperature process, deacetylation and disk refining (DDR) can produce high quality lignin. DDR uses a disk refiner and high pH to prepare plant feedstocks for enzyme deconstruction to sugars. The present disclosure uses at least two byproducts from the DDR process to create lignin products for use in cement and/or concrete applications.

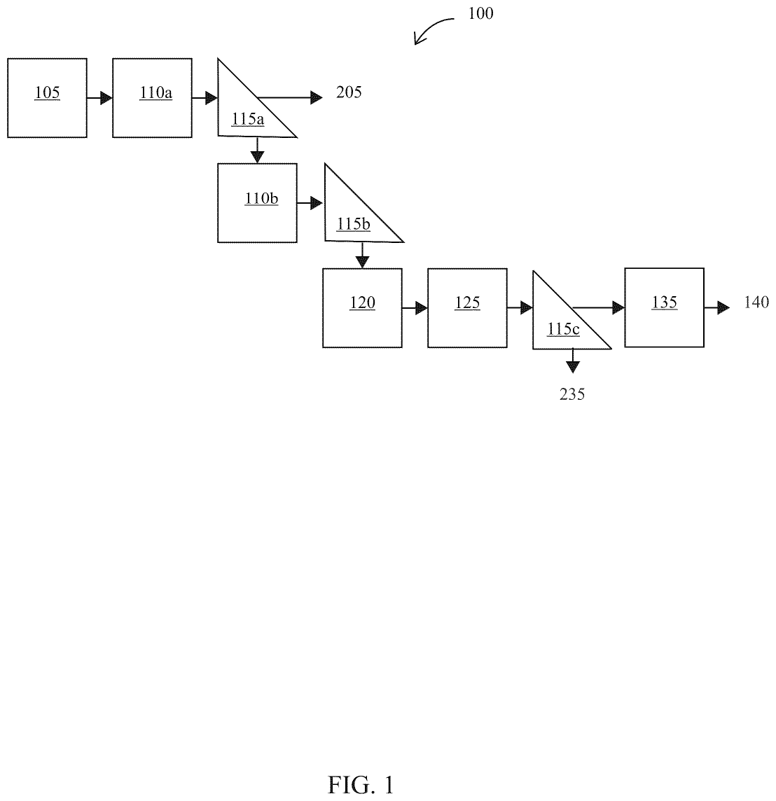

FIG. 1 illustrates a block diagram of a deacetylation and disk refining (DDR) process showing the origin of the lignin deacetylation byproducts utilized in the methods described herein. In the DDR process 100, a feedstock (typically corn, but other sources may be used) is milled 105 and a first deacetylation 110a is performed. From the first deacetylation 110a the solids are separated 115a out to continue moving through the DDR process 100. From the separation 115a a first black liquor 205 results, which is utilized in the method 200 described herein. The DDR process 100 continues with the solids separated 115b out after the first deacetylation 110a. These solids undergo a second deacetylation 110b and the resulting components are again separated 110b into solids and a second black liquor 230. The second black liquor 230 may be washed 235 with an acid, resulting in a lignin aerogel admixture 240.

The DDR process 100 continues with the solids separated 115b out after the second deacetylation 110. These solids undergo enzyme hydrolysis 120 and fermentation 125 before undergoing another solids separation 115c and finally being distilled 135 into sustainable aviation fuel (SAF) 140. Plants incorporate atmospheric CO₂ into their cell walls, which consist of cellulose, hemicellulose, and lignin. In most corn stover to biofuels processes, cellulose and hemicellulose are almost completely hydrolyzed to fermentable sugars, leaving a lignin-rich residue behind. The residue from enzyme hydrolysis 120 is known to consist primarily of lignin carbohydrate complexes (LCCs). The solids separated 115 out may be collected as enzyme hydrolysis (EH) solids 235.

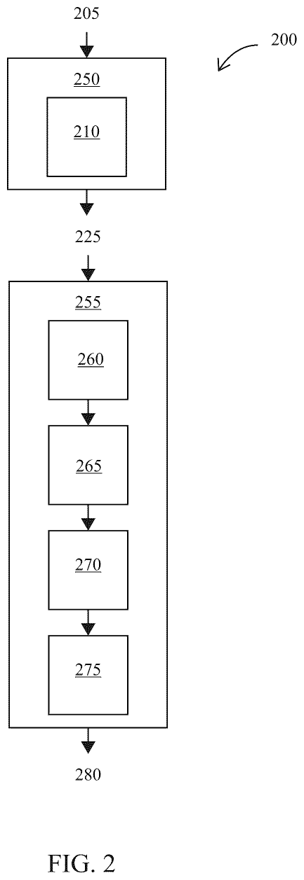

FIG. 2 illustrates a method 200 for treating a first black liquor 205 (i.e., a lignin deacetylation byproduct) from the DDR process 100 to form black liquor bioash (BLBA) 225 and using the BLBA 225 to create concrete 285, according to some aspects of the present disclosure. As shown in FIG. 2, in some embodiments, the first black liquor 205 from the DDR process 100 may be ashed (i.e., heated 210) and the nonvolative residues may be used as a replacement for OPC (i.e., by using BLBA 225 as an activator).

In some embodiments, the method 200 includes heating 210 the first black liquor 205, resulting in a lignin product that is a black liquor bioash (BLBA) 225. Note that the first black liquor 205 may initially be substantially liquid but may be heated and stirred until condensate is formed, the condensate may be used as the first black liquor 205 in the method 200. The heating 210 may be done until the first black liquor 205 reaches a temperature in the range of approximately 500° C. to approximately 600° C. The heating may be done for a time period in the range of approximately 10 minutes to approximately 600 minutes. In some embodiments, the heating 210 may be done until the first black liquor 205 reaches a temperature of approximately 575° C. in a furnace. In some embodiments, the heating 210 may comprise operating a furnace in a range of approximately 400° C. to approximately 700° C.

The silica rich BLBA 225 may be produced by oxidation in air (i.e., heating 210) under temperature-controlled ashing conditions. The BLBA 225 will be similar in chemical composition to traditional SCMs, rendering it well-suited for use as concrete bio-SCM. The high amorphous silica content of the BLBA 225 will enhance pozzolanic activity, increasing concrete strength.

In some embodiments, the heating 210 may be done in phases, with a furnace or other heating system being set to multiple temperature settings. For example, in exemplary preparation of the BLBA 225, a furnace was operated using four segments. The first segment had a ramp up rate of approximately 10° C./min and was operated at a temperature of approximately 105° C. for approximately 12 minutes. The second segment had a ramp up rate of approximately 10° C./min and was operated at a temperature of approximately 250° C. for approximately 30 minutes. The first segment had a ramp up rate of approximately 20° C./min and was operated at a temperature of approximately 575° C. for approximately 180 minutes. The fourth segment had a ramp up rate of approximately 5° C./min and was operated at a temperature of approximately 105° C. for greater than approximately 480° C.

In some embodiments, the method 200 next includes using 255 the BLBA 225 to create concrete. This BLBA 225 may be capable of sequestering additional carbon directly into its pores, further reducing the carbon footprint of concrete relative to traditional OPC. The high silica content of the BLBA 225 may enhance the pozzolanic activity of the resulting cement, thereby increasing the strength of the composite concrete.

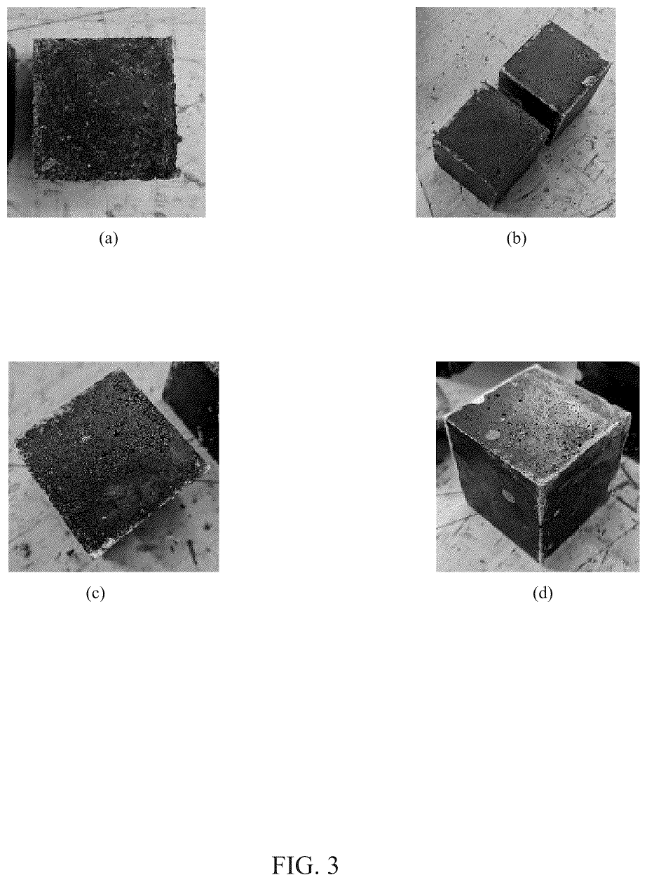

In some embodiments, the using 255 may first include combining 260 the BLBA 225 with at least one of an aggregate, a binder, or a silicate to form a dry mixture. The aggregate may be at least one of sand, gravel, or crushed rock. The binder may be at least one of fly ash, slag, mine tailings, or clay. As used herein “binder” may refer to any material or substance that holds or draws other materials together to form a cohesive whole. The amount of silicate in the dry mixture may be in the range of approximately 0% of the dry mixture to approximately 100% of the dry mixture. See FIG. 3 and Table 1.

In some embodiments, the first black liquor 205 and/or the BLBA 225 may be combined 260 with at least one binder to form alkali-activated materials (AAMs), which may act as an activator. The high alkaline content in the first black liquor 205 and BLBA 225 may provide the necessary alkalis to produce AAMs that have a lower embodied carbon footprint compared to tradition cementing materials (i.e., ordinary portland cement mortars and concretes), offer better temperature resistance (i.e., flame retardancy) and acid resistance. In some embodiments, the using 255 may include combining 260 the BLBA 225 with a cement. The cement may be at least one of ordinary portland cement or portland lime cement. See Table 1 and FIG. 3.

In some embodiments, the using 255 may next include adding 265 water to the dry mixture to form a wet concrete. The amount of water that may be added based on the volume of dry materials. The wet concrete may be substantially sludge or mud like and capable of being stirred. In some embodiments, the combining 260 and/or the adding 265 may be performed in a concrete mixer or large blender.

In some embodiments, the using 255 may next include casting 270 the wet concrete. The casting 270 may include pouring the wet concrete into a mold or in between siding or edging in a designated location. The casting 270 results in the wet concrete being in the desired location, shape, orientation, and/or configuration of the final resulting dry concrete.

In some embodiments, the using 255 may next include curing 275 the wet concrete to form a dry concrete. The curing 275 may be done at substantially ambient conditions (i.e., the temperature, pressure, and humidity of the surrounding environment). In some embodiments, the curing 275 may be done by heating the wet concrete (i.e., by providing heat through a heat lamp, furnace, or other heat source). The curing 275 may be done at a temperature in the range of approximately 0° C. to approximately 100° C. The curing 275 may be done at a pressure in the range of approximately 5 psi to approximately 20 psi. The curing 275 may be done at humidity in the range of approximately 25% to approximately 100%. In testing, the cured 275 dry concrete were approximately 50 mm×50 mm×50 mm with a volume of approximately 125,000 mm³. However, other shapes and sizes may be used.

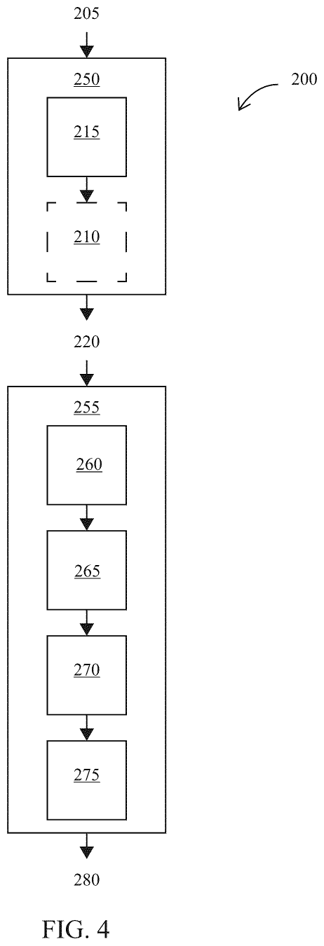

Note for the method 200 shown in FIGS. 4-6, the adding 265, casting 270, and/or curing 275 may be substantially similar to the adding 265, casting 270, and/or curing 275 as described for FIG. 2.

In some embodiments, the first black liquor 205, with its inherent sodium carbonate and sodium hydroxide concentration, can be used as the alkaline activation solution for aluminosilicate precursor powders (e.g., fly ash, slag, metakaolin). In the methods described herein, the first black liquor 205 may replace the need for alkaline sodium hydroxide/sodium silicate solutions that are prepared from solid pellets. In some embodiments, BLBA 225 produced from the first black liquor 205 can be added to the aluminosilicate precursors as a “dry” activating powder, where water can then be added to the mixture and mixed together to create AAMs. The AAMs may be stabilized by a sodium aluminosilicate hydrate framework (N-A-S-H), which may be used in various applications. In some embodiments, other waste materials high in silicates (i.e., waste glass) may be incorporated into the AAMs to enhance the material properties to further develop the N-A-S-H framework and compressive strength. In some embodiments, the black liquor derived AAMs may utilize multiple byproducts and waste streams from various industries and can provide an alternative to ordinary Portland cement-based mortars and concretes.

As shown in Table 1 and FIG. 3, the amount of silicate in the dry mixture (and thus in the wet concrete and ultimately the dry concrete) were varied. In FIG. 3, (a) corresponds to the control (approximately 100% Na₂SiO₃), (b) corresponds to BLBA 225 in a 2:1 ratio with Na₂SiO₃, (c) corresponds to BLBA 225 in a 5:1 ratio with Na₂SiO₃, and (d) corresponds to approximately 100% BLBA 225.

TABLE 1
Mixture portions for dry concrete with various amounts of BLBA.

| | Mixture Proportions | | | | | | | |
|---|---|---|---|---|---|---|---|---|
| | Slag | | BLBA | Reporting proportions (kg/m3) | | | | |
| Mixture Name | (%) | Na₂SiO₃ (%) | (%) | Sand | Slag | Na₂SiO₃ | BLBA | Water |
| Control (100% | 70.0 | 30.0 | 0.0 | 1444.6 | 337.1 | 144.5 | 0.0 | 240.8 |
| Na₂SiO₃) | | | | | | | | |
| BLBA 2:1 Na₂SiO₃ | 70.0 | 10.0 | 20.0 | 1375.2 | 320.9 | 45.8 | 91.7 | 229.2 |
| BLBA 5:1 Na₂SiO₃ | 70.0 | 5.0 | 25.0 | 1358.9 | 317.1 | 22.6 | 113.2 | 226.5 |
| 100% BLBA | 70.0 | 0.0 | 30.0 | 1343.0 | 313.4 | 0.0 | 134.3 | 223.8 |

As shown in Table 1 and FIG. 3, the BLBA 225 was combined 260 with an aggregate (sand), a binder (slag), and a silicate (Na₂SiO₃) to form a dry mixture. Then water was added 265 to the dry mixture to form wet concrete. For the example of FIG. 3, the wet concrete was cast 270 into small substantially cubic molds and allowed to cure 275 at ambient conditions in Golden, CO (a temperature of approximately 25° C. and a relative humidity of approximately 70%).

In some embodiments, there may be at least two sources of alkalis from the combination of the first black liquor 205 and the BLBA 225 Depending on the aluminosilicate precursor chemistry one or a combination of the first black liquor 205 and the BLBA 225 can be a suitable replacement for the alkaline activating solution and/or a traditional cement product.

FIG. 4 illustrates a method 200 for treating the first black liquor 205 from the DDR process 100 to form activated lignin carbon (ALC) and using the ALC to create concrete, according to some aspects of the present disclosure. In some embodiments, the method 200 includes pyrolyzing 215 the first black liquor 205, resulting in a lignin product that is an activated lignin carbon (ALC) 220. The pyrolyzing 215 may be done by heating the first black liquor in a substantially inert environment to a temperature in the range of approximately 500° C. to approximately 700° C. As used herein, pyrolysis and pyrolyzing may refer to heating a material in the absence of oxygen. In some embodiments, a substantially inert environment may be substantially sealed (i.e., closed to the ambient) and filled with an inert gas, such as nitrogen, argon, or helium. In exemplary preparation of the ALC 220, a sealed furnace was filled with nitrogen (N₂) gas was used to pyrolyze 215 the first black liquor 205. For three samples of the first black liquor 205, in exemplary preparation of the ALC 220, three conditions were used for the furnace. For a first sample, at a ramp up rate of approximately 5° C./min, the furnace was heated to approximately 500° C. and held for approximately 5 hours. The resulting ALC 220 was charred. For a second sample, at a ramp up rate of approximately 5° C./min, the furnace was heated to approximately 600° C. and held for approximately 2 hours. The resulting ALC 220 was charred and expanded from its pre-pyrolyzed state. For a third sample, at a ramp up rate of approximately 5° C./min, the furnace was heated to approximately 700° C. and held for approximately 30 minutes (or approximately 0.5 hours). The resulting ALC 220 turned green, indicating full combustion, and demonstrating that this temperature may have been less optimal than slightly lower temperatures.

In some embodiments, post-treatment of ALC 220 via oxidation (i.e., heating 210) may be used for cement purposes. This heating 210 may be in the range of approximately 200° C. to approximately 500° C. with exposure to oxygen in concentrations in the range of approximately 1% to approximately 100% for a time in the range of approximately 1 second to approximately 10 hours. In testing, charred ALC 220 produced under oxidative environments showed induced higher strength gains and traditional chars.

In some embodiments, the ALC 220 may be used as a supplementary cementitious material (SCM) during the using 255. Otherwise, the using 255 may be substantially similar to the using 255 as described in FIG. 2.

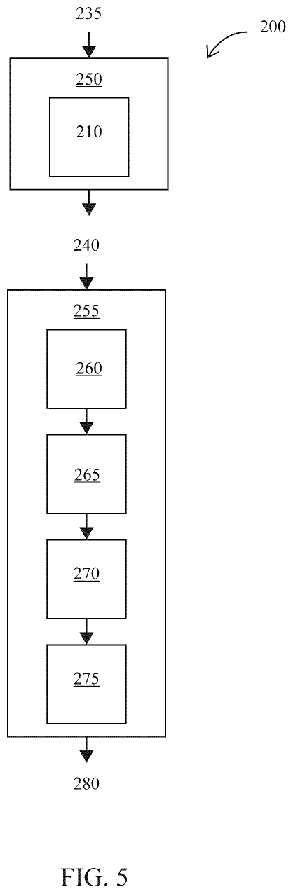

FIG. 5 illustrates a method 200 for treating enzyme hydrolysis (EH) solids 235 (i.e., a lignin deacetylation byproduct) from the DDR process 100 to form an ash 240 and using the ash 240 to create concrete 280, according to some aspects of the present disclosure. In the method 200, the treating 250 may include heating 210 the EH solids 235 to create the ash 240. The heating 210 may be done until the EH solids 235 reaches a temperature in the range of approximately 500° C. to approximately 600° C. The heating may be done for a time in the range of approximately 10 minutes to approximately 600 minutes. In some embodiments, the heating 210 may be done until the EH solids 235 reaches a temperature of approximately 575° C. in a furnace. In some embodiments, the heating 210 may comprise operating a furnace in a range of approximately 400° C. to approximately 700° C. The ash 240 resulting from the heating 210 may be substantially similar to BLBA 225 and may be used similarly during the using 255.

### Examples

Example 1. A method comprising:
treating a lignin deacetylation byproduct to form a lignin product; and
using the lignin product to form a concrete.

Example 2. The method of Example 1, wherein:
the lignin deacetylation byproduct comprises a first black liquor, and
the treating comprises heating the first black liquor.

Example 3. The method of Example 2, wherein:
the heating comprises heating the first black liquor to a temperature of less than approximately 600° C., and
the lignin product comprises a black liquor bioash (BLBA).

Example 4. The method of Example 3, wherein:
the heating is performed in a furnace, and
the furnace is configured to heat the first black liquor to a temperature of approximately 575° C.

Example 5. the method of Example 3, wherein:
the using comprises:
combining the BLBA with an aggregate, a silicate, and a binder to form a dry mixture;
adding a water and the first black liquor to the dry mixture to form a wet concrete;
casting the wet concrete; and
curing the wet concrete to form a dry concrete.

Example 6. The method of Example 5, wherein:
the aggregate comprises at least one of sand, gravel, or crushed rock.

Example 7. The method of Example 5, wherein:
the binder comprises at least one of fly ash, slag, mine tailings, or clay.

Example 8. The method of Example 5, wherein:
the silicate comprises at least one of sodium silicate or calcium silicate.

Example 9. The method of Example 5, wherein:
the silicate comprises at least one of glass, ceramic, waterglass, granite, gravel, or garnet.

Example 10. The method of Example 1, wherein:
the lignin deacetylation byproduct comprises a first black liquor,
the treating comprises pyrolyzing the first black liquor in a substantially inert environment at a temperature of less than approximately 600° C., and
the lignin product comprises an activated lignin carbon (ALC).

Example 11 The method of Example 10, wherein:
the using comprises combing the ALC with an aggregate, an activator, and a water.

Example 12. The method of Example 11, wherein:
the aggregate comprises at least one of sand, gravel, or crushed rock.

Example 13. The method of Example 11, wherein:
the activator comprises a cement.

Example 14. The method of Example 13, wherein:
the cement comprises at least one of ordinary portland cement or portland limestone cement.

Example 15. The method of Example 11, wherein:
the activator comprises a black liquor bioash (BLBA) and a silicate.

Example 16. The method of Example 15, wherein:
the silicate comprises at least one of sodium silicate or calcium silicate.

Example 17. The method of Example 15, wherein:
the silicate comprises at least one of glass, ceramic, waterglass, granite, gravel, or garnet.

Example 18. The method of Example 15, wherein:
the activator further comprises the first black liquor in liquid form.

Example 19. The method of Example 1, wherein:
the lignin deacetylation byproduct comprises an enzyme hydrolysis (EH) solid,
the treating comprises heating the EH solid to a temperature of less than approximately 600° C.; wherein:
the heating results in an ash.

Example 20. The method of Example 1, wherein:
the using comprises combining the lignin product with a cement.

Example 21. The method of Example 20, wherein:
the cement comprises at least one of ordinary portland cement or portland limestone cement.

Example 22. The method of Example 1, wherein:
the using comprises:
combining the lignin product with an aggregate and a binder to form a dry mixture;
adding a water to the dry mixture to form a wet concrete;
casting the wet concrete; and
curing the wet concrete to form a dry concrete.

Example 23. The method of Example 22, wherein:
the aggregate comprises at least one of sand, gravel, or crushed rock.

Example 24. The method of Example 22, wherein:
the binder comprises at least one of fly ash, slag, mine tailings, or clay.

Example 25. The method of Example 22, wherein:
the binder comprises at least one of ordinary portland cement or portland limestone cement.

The foregoing discussion and examples have been presented for purposes of illustration and description. The foregoing is not intended to limit the aspects, embodiments, or configurations to the form or forms disclosed herein. In the foregoing Detailed Description for example, various features of the aspects, embodiments, or configurations are grouped together in one or more embodiments, configurations, or aspects for the purpose of streamlining the disclosure. The features of the aspects, embodiments, or configurations may be combined in alternate aspects, embodiments, or configurations other than those discussed above. This method of disclosure is not to be interpreted as reflecting an intention that the aspects, embodiments, or configurations require more features than are expressly recited in each claim. Rather, as the following claims reflect, inventive aspects lie in less than all features of a single foregoing disclosed embodiment, configuration, or aspect. While certain aspects of conventional technology have been discussed to facilitate disclosure of some embodiments of the present invention, the Applicants in no way disclaim these technical aspects, and it is contemplated that the claimed invention may encompass one or more of the conventional technical aspects discussed herein. Thus, the following claims are hereby incorporated into this Detailed Description, with each claim standing on its own as a separate aspect, embodiment, or configuration.

What is claimed is:

1. A method comprising:
treating a lignin deacetylation byproduct to form a lignin product; and
using the lignin product to form a concrete.

2. The method of claim 1, wherein:
the lignin deacetylation byproduct comprises a first black liquor, and
the treating comprises heating the first black liquor.

3. The method of claim 2, wherein:
the heating comprises heating the first black liquor to a temperature of less than approximately 600° C., and
the lignin product comprises a black liquor bioash (BLBA).

4. The method of claim 3, wherein:
the heating is performed in a furnace, and
the furnace is configured to heat the first black liquor to a temperature of approximately 575° C.

5. the method of claim 3, wherein:
the using comprises:
combining the BLBA with an aggregate, a silicate, and a binder to form a dry mixture;
adding a water and the first black liquor to the dry mixture to form a wet concrete;
casting the wet concrete; and
curing the wet concrete to form a dry concrete.

6. The method of claim 5, wherein:
the aggregate comprises at least one of sand, gravel, or crushed rock.

7. The method of claim 5, wherein:
the binder comprises at least one of fly ash, slag, mine tailings, or clay.

8. The method of claim 5, wherein:
the silicate comprises at least one of sodium silicate or calcium silicate.

9. The method of claim 5, wherein:
the silicate comprises at least one of glass, ceramic, waterglass, granite, gravel, or garnet.

10. The method of claim 1, wherein:
the lignin deacetylation byproduct comprises a first black liquor,
the treating comprises pyrolyzing the first black liquor in a substantially inert environment at a temperature of less than approximately 600° C., and
the lignin product comprises an activated lignin carbon (ALC).

11. The method of claim 10, wherein:
the using comprises combing the ALC with an aggregate, an activator, and a water.

12. The method of claim 11, wherein:
the aggregate comprises at least one of sand, gravel, or crushed rock.

13. The method of claim 11, wherein:
the activator comprises a cement.

14. The method of claim 13, wherein:
the cement comprises at least one of ordinary portland cement or portland limestone cement.

15. The method of claim 11, wherein:
the activator comprises a black liquor bioash (BLBA) and a silicate.

16. The method of claim 15, wherein:
the silicate comprises at least one of sodium silicate or calcium silicate.

17. The method of claim 15, wherein:
the silicate comprises at least one of glass, ceramic, waterglass, granite, gravel, or garnet.

18. The method of claim 1, wherein:
the lignin deacetylation byproduct comprises an enzyme hydrolysis (EH) solid,
the treating comprises heating the EH solid to a temperature of less than approximately 600° C.; wherein:
the heating results in an ash.

19. The method of claim 1, wherein:
the using comprises combining the lignin product with a cement.

20. The method of claim 19, wherein:
the cement comprises at least one of ordinary portland cement or portland limestone cement.
